(19) United States
(12) Patent Application Publication
(10) Pub. No.: US 2006/0293427 A1
(43) Pub. Date: Dec. 28, 2006

(54) Thermally conductive polyamide-based components used in light emitting diode reflector applications

(76) Inventors: Marvin M. Martens, Vienna, WV (US); Georgio Topoulos, Geneva (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/449,364

(22) Filed: Jun. 8, 2006

Related U.S. Application Data
(60) Provisional application No. 60/689,775, filed on Jun. 10, 2005.

(51) Int. Cl. C08G 69/26; C08K 3/38

(52) U.S. Cl. 524/404; 524/606; 524/430

(57) ABSTRACT

Articles associated with light emitting diode assemblies are disclosed which are made from polyamide resin compositions and thermally conductive materials such as Al2O3, boron nitride, boron carbide, calcium fluoride, and aluminum nitride, and optionally fillers and/or additives.

### CROSS REFERENCE TO RELATED APPLICATIONS

This application claims the benefit of priority to U.S. Provisional Application No. 60/689,775, filed Jun. 10, 2005.

### FIELD OF THE INVENTION

The present invention relates to thermally conductive articles for use in light emitting diodes or so-called “LED's” and manufactured from polyamide resin compositions. More specifically the present invention relates to any of a variety of substrates, surfaces, housings and the like made from polyamide resin compositions and to which are affixed or secured LED's, whereby such substrates and the like offer superior heat dissipation properties.

### BACKGROUND OF THE INVENTION

Because of their excellent mechanical properties, polyamide resin compositions are used in a broad range of applications such as in automotive parts, electrical and electronic parts, machine parts and the like. In many cases, because of the design flexibility they permit and their low cost, polymer resin compositions have replaced metal in these applications. However, many of these applications require that the parts be in the vicinity of or in contact with heat sources such as motors or electrical lights. And in LED's particularly, heat generated from electric current is a concern. It is therefore desirable to form these parts from materials that are sufficiently thermally conductive to dissipate the heat generated. While metal parts are thermally conductive, they are also electrically conductive, which can be undesirable in certain applications. Polyamide resin compositions are generally thermally insulating and typically electrically insulating unless they contain large amounts of electrically conductive additives. Thus, a thermally conductive, electrically insulating polyamide resin composition would be desirable and could replace metals in many applications.

In general polyamide resin compositions offer excellent fluidity during conventional molding processes, making them the material of choice for a wide spectrum of molding applications. Moreover polyamide compositions have been tailored to suit any of a number of demanding applications requiring exceptional mechanical characteristics, heat resistance, chemical resistance and/or dimensional stability when moisture is absorbed. It is not surprising then that polyamides enjoy a wide range of applications, including parts used in automobiles, electrical/electronic parts, and furniture.

As parts of electrical/electronic products, such as sealants for connectors, coil bobbins and so forth it is possible to make use of polyamide resin compositions. For these sealants, in addition to the high solder heat resistance, the parts should have a small thickness to reduce the overall weight of the parts. As nylon 66 has good fluidity, it is able to flow through the narrow gaps in the molding dies, so that thin-wall moldings can be formed. On the contrary, the solder heat resistance is poor. Moreover, nylon 6,6 shows variations in dimensions and properties as moisture is absorbed. Consequently, it is necessary to predict these variations and to take the appropriate measures in designing the parts. Because their applications are limited, and they are inappropriate for manufacturing high-precision parts. These are serious disadvantages.

Of particular interest, many materials currently available in the marketplace today do little to assist with the dissipation of heat build up common in demanding electronics applications where increasingly higher levels of power are the norm.

Accordingly, it is an object of the invention to provide articles associated with LED components (such as housings, reflectors, reflector cups, scramblers and the like) and made from specialized polyamide compositions which demonstrate superior thermal conductivity while maintaining excellent fluidity in the molding operation. A further object of the invention is to provide such a polyamide resin composition suitable for molding these components and having excellent mechanical characteristics, chemical resistance and dimensional stability upon moisture absorption. A feature of the instantly disclosed compositions is their suitability in demanding electronics applications to facilitate the dissipation of heat typically generated in components which draw significant power. Another feature of these preferred materials is that they provide thermal conductivity however without deleterious electric conductivity. It is an advantage of the invention to provide articles made from this composition which have as attributes resistance to blistering, discoloration and heat aging; and better reflectability; and further that such articles can withstand soldering operations. These and other objects, features and advantages of the present invention will become better known and understood upon having reference to the following description of the invention.

### SUMMARY OF THE INVENTION

There is disclosed and claimed herein a thermally conductive component of a light emitting diode assembly, wherein said component comprises a polyamide resin composition comprising
(a) about 15 to about 70 weight percent of a semiaromatic polyamide, and
(b) about 30 to about 85 weight percent thermally conductive material, wherein the weight percentages are based on the total weight of the composition.

### DETAILED DESCRIPTION OF THE INVENTION

Light emitting diodes are widely used in a variety of electronics applications where bright lighting is desirable. In these applications the LED is typically attached to a substrate and positioned within or along a relective surface so that its lighting characteristics are enhanced and directed in a desirable manner. LEDs have recently been the subject of renewed attention with the recent development of blue light in these applications. Inasmuch as previous applications incorporated light emitting diodes of red and green, the addition of blue light greatly expands the role and possible applications of LEDs.

However the materials used in conjunction with electronics applications typically face demanding challenges, largely due to the poor adhesive qualities of sealing materials, undesirable moisture absorption associated with conventional materials, poor thermal properties, thermal oxidation, blistering in soldering applications, and the like. Accordingly, there is disclosed and claimed herein polyamide resin compositions offering superior mechanical properties and enhanced to promote thermal conductivity and heat dissipative properties, an effective combination for use of such materials in LED applications.

The thermoplastic semiaromatic polyamide used in the present invention is one or more homopolymers, copolymers, terpolymers, or higher polymers that are derived, at least in part, from monomers comprising aromatic dicarboxylic acids and aliphatic or alicyclic diamines. It may also be a blend of one or more homopolymers, copolymers, terpolymers, or higher polymers that are derived at least in part, from dicarboxylic acids containing aromatic groups and aliphatic or alicyclic diamines with one or more aliphatic polyamides.

Preferred aromatic dicarboxylic acid monomers are terephthalic acid and isophthalic acid. It is preferred that about 10 to about 100 mole percent of dicarboxylic acid monomers used to make the semiaromatic polyamide used in the present invention contain aromatic groups. Thus, preferably, about 10 to about 100 mole percent of the repeat units of the semiaromatic polyamides contain aromatic groups.

The semiaromatic polyamide may optionally contain repeat units derived from one or more additional aliphatic dicarboxylic acid monomers or their derivatives, such as adipic acid, sebacic acid, azelaic acid, dodecanedioic acid, and other aliphatic or alicyclic dicarboxylic acid monomers having 4 to 20 carbon atoms.

As will be understood by those skilled in the art, the polyamide of this invention may be prepared from not only the dicarboxylic acids, but their corresponding carboxylic acid derivatives, which can include carboxylic acid esters, diesters, and acid chlorides, and as used herein, the term “dicarboxylic acid” refers to such derivatives as well as the dicarboxylic acids themselves.

The semiaromatic polyamide is preferably derived from aliphatic and/or alicyclic diamine monomers having 4 to 20 carbon atoms. More preferably, the diamine monomers are aliphatic diamines having 8 to 20 carbon atoms. Yet more preferably, the diamine monomers are aliphatic diamines having 10 to 20 carbon atoms. Preferred aliphatic diamines may be linear or branched and include hexamethylenediamine; 2-methyl-1,5-pentanediamine; 1,8-diaminooctane; 1,9-diaminononane; methyl-1,8-diaminooctane; 1,10-diaminodecane; and 1,12-diaminododecane. Examples of alicyclic diamines include 1-amino-3-aminomethyl-3,5,5,-trimethylcyclohexane; 1,4-bis(aminomethyl)cyclohexane; and bis(p-aminocyclohexyl)methane.

The semiaromatic polyamide may optionally contain repeat units derived from lactams and aminocarboxylic acids (or acid derivatives), such as caprolactam, 11-aminoundecanoic acid, and laurolactam.

Examples of preferred semiaromatic polyamides include hexamethylene adipamide/hexamethylene terephthalamide copolyamide (polyamide 6,T/6,6); hexamethylene terephthalamide/2-methylpentamethylene terephthalamide copolyamide (polyamide 6,T/D,T); poly(dodecamethylene terephthalamide) (polyamide 12,T); poly(decamethylene terephthalamide) (polyamide 10,T); decamethylene terephthalamide/decamethylene dodecanoamide copolyamide (10,T/10,12); poly(nonamethylene terephthalamide) (polyamide 9,T); the polyamide of hexamethylene isophthalamide and hexamethylene adipamide (polyamide 6,I/6,6); the polyamide of hexamethylene terephthalamide, hexamethylene isophthalamide, and hexamethylene adipamide (polyamide 6,T/6,I/6,6); and copolymers and mixtures of these polymers.

Other preferred semiaromatic polyamides include one or more of polyamides derived from: terephthalic acid, isophthalic acid, and 1,10-diaminodecane; terephthalic acid, 1,10-diaminodecane, and 1,12-diaminododecane; terephthalic acid, dodecanedioic acid, and 1,10-diaminodecane; terephthalic acid, sebacic acid, and 1,10-diaminodecane; terephthalic acid, adipic acid, and 1,10-diaminodecane; terephthalic acid, dodecanedioic acid, 1,10-diaminodecane, and hexamethylenediamine; terephthalic acid, adipic acid, 1,10-diaminodecane, and hexamethylenediamine; terephthalic acid, 1,10-diaminodecane, and hexamethylenediamine; terephthalic acid, adipic acid, 1,10-diaminodecane, and dodecanedioic acid; terephthalic acid, 1,10-diaminodecane, and 11-aminoundecanoic acid; terephthalic acid, 1,10-diaminodecane, and laurolactam; terephthalic acid, 1,10-diaminodecane, and caprolactam; terephthalic acid, 1,10-diaminodecane, and 2-methyl-1,5-petanediamine; terephthalic acid, adipic acid, 1,10-diaminodecane, and 2-methyl-1,5-petanediamine; terephthalic acid, isophthalic acid, and 1,12-diaminododecane; terephthalic acid, dodecanedioic acid, and 1,12-diaminododecane; terephthalic acid, sebacic acid, and 1,12-diaminododecane; terephthalic acid, adipic acid, and 1,12-diaminododecane; terephthalic acid, dodecanedioic acid, 1,12-diaminododecane, and hexamethylenediamine; terephthalic acid, adipic acid, 1,12-diaminododecane, and hexamethylenediamine; terephthalic acid, adipic acid, and 1,12-diaminododecane; hexamethylenediamine; terephthalic acid, adipic acid, 1,12-diaminododecane, and dodecanedioic acid; terephthalic acid, 1,12-diaminododecane, and 11-aminoundecanoic acid; terephthalic acid, 1,12-diaminododecane, and laurolactam; terephthalic acid, 1,12-diaminododecane, and caprolactam; terephthalic acid, 1,12-diaminododecane, and 2-methyl-1,5-petanediamine; and terephthalic acid, adipic acid, 1,12-diaminododecane, and 2-methyl-1,5-petanediamine.

In a preferred embodiment, the semiaromatic polyamide will be derived from dicarboxylic acid monomers comprising about 75 to about 100 mole percent or preferably from about 80 to about 95 mole percent terephthalic acid and diamine monomers comprising about 75 to 100 mole percent aliphatic diamines having 8 to 20 carbon atoms. In a more preferred embodiment, the semiaromatic polyamide will be derived from dicarboxylic acid monomers comprising about 75 to about 100 mole percent or preferably from about 80 to about 95 mole percent terephthalic acid and diamine monomers comprising about 75 to 100 mole percent aliphatic diamines having 10 to 20 carbon atoms The semicrystalline polyamide will preferably have a melting point that is at least about 270° C. and more preferably at least about 280° C. and is preferably less than about 340° C.

The polyamide resin compositions of the invention are made thermally conductive but not susceptible of conducting electrical current therewithin. The latter requirement is essential because within the current LED technologies and applications it is important that the polymer composition is a strong insulator and does not transmit electric current, so that the functionality of the LED device is not impaired. For example, many applications require in their technical specifications that low ionic content be maintained in the polymer in order to prevent any interference with an LED supply current and LED semi-conductive operations. On the other hand the thermal conductivity of the polymer composition would be of great advantage, inasmuch as with the increasing power of the LEDs there is a significant need for heat evacuation. With improved cooling of the LED device a higher LED luminous output can be achieved. By “thermally conductive material” is meant materials that dissipate heat from the source of heat, such as heat from diodes in semiconductors. Such materials include those having thermal conductivity of at least about 5 watts/m K.

Accordingly, the instantly disclosed polyamide compositions are suitably modified to provide thermal conductivity but without electric conductivity. Without intending to limit the generality of the foregoing, representative materials for this purpose include Al2O3, boron nitride, boron carbide, calcium fluoride and aluminum nitride. Of these, Al2O3, boron nitride, calcium fluoride, and boron carbide are preferred. Overall as a class these materials may be incorporated in amounts ranging from about 30 to about 85 weight percent, preferably from about 20 to about 70 weight percent, and most preferably from about 30 to about 50 weight percent, based on the total weight of the composition.

Further, for the polyamide resin composition of this invention, inorganic fillers can be incorporated so long as they are of a type or incorporated in an amount that does not alter or modify the total composition to make it electrically conductive. Such fillers typically include glass fibers, calcium titanate, whiskers, kaolin, talc, mica, Wollastonite etc. If it is necessary to increase the mechanical strength of the molding, it is preferable to add glass fibers. If it is necessary to increase the dimensional stability of the molding and to suppress warpage, kaolin, talc, mica or glass flakes may be added.

Preferred filler types are inorganic fillers such as glass fibers and mineral fillers or mixtures thereof. The concentration of fillers in the filled composition can be selected according to the usual practice of those having skill in this field.

The compositions of the present invention can contain one or more additives known in the art, such as stabilizers, antioxidants, lubricants, flame retardants and colorants, as long as these additives do not deleteriously affect the performance of the polyamide composition. In addition, for the polyamide resin composition of the invention, as long as the characteristics of the obtained molding are not degraded, other additives, such as plasticizers, oxidation inhibitors, dyes, pigments, mold release agents, etc may be added in appropriate amounts in addition to the aforementioned polyamide, thermally conductive material, and filler.

The compositions of the invention may be prepared by blending the polyamide, conductive material, and filler and then melt compounding the blend to form the composition. Such melt compounding may be carried out in single screw extruders equipped with suitable mixing screws, but is more preferably carried out in twin screw extruders.

The polyamide can be made by methods known in the art. For example, a polyamide can be prepared by a process comprising the steps of:
(a) feeding to a reactor an aqueous salt solution of an admixture of carboxylic acid and diamine;
(b) heating the aqueous salt solution under pressure until the pressure in the reactor reaches at least about 1300 kPa, with water (in the form of steam) and other volatile matter being vented from the reactor;
(c) when the temperature of the reaction mixture has reached a temperature of at least about 270 C, preferably 280-320 C, reducing the pressure in the reactor to atmospheric pressure over a period of at least 15 minutes in a manner that avoids excessive foaming of the reaction mixture;
(d) maintaining the reaction mixture at a pressure that is not greater than about atmospheric pressure, preferably under vacuum, until the polyamide formed has reached a predetermined molecular weight; and
(e) discharging the polyamide from the reactor.

It will be understood by persons skilled in the art, that the polyamide used in the present invention can also be manufactured using solid phase polymerization, extrusion polymerization, continuous polymerization, and the like. The thermally conductive material is likewise incorporated into the polymer using any of a variety of conventional techniques as understood by the person of skill.

The compositions of the present invention may be in the form of a melt-mixed blend, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method. The component materials may be mixed to homogeneity using a melt-mixer such as a single or twin-screw extruder, blender, kneader, Banbury mixer, etc. to give a resin composition. Part of the materials may be mixed in a melt-mixer, and the rest of the materials may then be added and further melt-mixed until homogeneous. The sequence of mixing in the manufacture of the thermally conductive polyamide resin composition of this invention may be such that individual components may be melted in one shot, or the filler and/or other components may be fed from a side feeder, and the like, as will be understood by those skilled in the a rt.

The composition of the present invention may be formed into articles using methods known to those skilled in the art, such as, for example, injection molding, blow molding, or extrusion. Such articles can include those for use in motor housings, lamp housings, LED housings, lamp housings in automobiles and other vehicles, and electrical and electronic housings. Examples of lamp housings in automobiles and other vehicles are front and rear lights, including headlights, tail lights, and brake lights, particularly those that use light-emitting diode (LED) lamps. LED radiators made from the present compositions are also attractive.

Other methods of production of the polyamide can be used which are well known in the art. For example, the polyamide resin(s) can be produced by condensation of equimolar amounts of saturated dicarboxylic acid with a diamine. Excess diamine can be employed to provide an excess of amine end groups in the polyamide. It is also possible to use in this invention polyamides prepared by the copolymerization or terpolymerization.

Preferably, to avoid excessive polymer degradation during compounding and injection molding, all polymer preblends and compounded blends should be pre-dried to a moisture content below about 0.05%. The ingredients are then mixed in their proper proportions in a suitable vessel such as a drum or a plastic bag. The mixture is then melt blended, preferably in a single or twin screw extruder, at a melt temperature, measured at the exit of the extruder die, preferably in the range of about 310 C to 370 C. Melt temperatures significantly above 370 C, generally, should be avoided to keep degradation of the polyamide to a minimum. It will be understood by persons skilled in the art that the appropriate melt temperature can be determined easily, without undue experimentation.

For good dispersion of all components, it is preferable to use a twin screw extruder with appropriate screw design, although single screw extruders are suitable as well. Appropriate screw design can also be easily determined, without undue epxerimentation, by persons skilled in the art. Moreover for preparing the moldings of the present invention, various conventional molding methods may be adopted, such as compression molding, injection molding, blow molding and extrusion molding. Also, depending on the demand, it is possible to post process the molding to form the product.

The compositions of the present invention can be used in the manufacture of a wide variety of components associated with or incorporating LED's and using melt processing techniques. Such products are intended for use at temperatures that are higher than those typically used with other polyamide compositions. Of particular interest, the compositions of the present invention can be formed into articles incorporated into LED assemblies and where heat dissipation properties are important. These compositions find utility in end uses where retention of properties at elevated tempaeratures is a required attribute.

1. A thermally conductive component of a light emitting diode assembly, wherein said component comprises a polyamide resin composition comprising
(a) about 15 to about 70 weight percent of a semiaromatic polyamide, and
(b) about 30 to about 85 weight percent thermally conductive material, wherein the weight percentages are based on the total weight of the composition.

2. The component of claim 1, wherein the semiaromatic polyamide is one or more of hexamethylene adipamide/hexamethylene terephthalamide copolyamide (polyamide 6,T/6,6); hexamethylene terephthalamide/2-methylpentamethylene terephthalamide copolyamide (polyamide 6,T/D,T); poly(dodecamethylene terephthalamide) (polyamide 12,T); poly(decamethylene terephthalamide) (polyamide 10,T); decamethylene terephthalamide/decamethylene dodecanoamide copolyamide (10,T/10,12); poly(nonamethylene terephthalamide) (polyamide 9,T); the polyamide of hexamethylene isophthalamide and hexamethylene adipamide (polyamide 6,I/6,6); the polyamide of hexamethylene terephthalamide, hexamethylene isophthalamide, and hexamethylene adipamide (polyamide 6,T/6,I/6,6).

3. The component of claim 1, wherein the semiaromatic polyamide is derived from
(a) dicarboxylic acid monomers comprising terephthalic acid and, optionally, one or more additional aromatic and/or aliphatic dicarboxylic acids;
(b) diamine monomers comprising one or more aliphatic diamines having 8 to 20 carbon atoms and, optionally, one or more additional diamines; and
(c) optionally, one or more aminocarboxylic acids and/or lactams.

4. The component of claim 3, wherein component (b) is one or more aliphatic diamines having 10 to 20 carbon atoms and, optionally, one or more additional diamines.

5. The component of claim 3, wherein the dicarboxylic acid monomers comprise about 75 to 100 mole percent terephthalic acid.

6. The component of claim 3, wherein the dicarboxylic acid monomers comprise about 80 to 95 mole percent terephthalic acid.

7. The component of claim 3, wherein the diamine monomers comprise about 75 to 100 mole percent aliphatic diamines having 8 to 20 carbon atoms.

8. The component of claim 3, wherein the dicarboxylic acid monomers comprise about 50 to 100 mole percent terephthalic acid and 0 to about 50 mole percent of at least one aromatic dicarboxylic acid other than terephthalic acid and/or at least one aliphatic dicarboxylic acid having 4 to 20 carbon atoms; and wherein the diamine monomers comprise about 50 to 100 mole percent of one or more diamines having from 10 to 20 carbon atoms 0 to about 50 mole percent of at least one aliphatic diamine having from 4 to 9 carbon atoms but other than 1,9-diaminononane.

9. The component of claim 1 further selected from the group consisting of housings, reflectors, reflector cups, and scramblers.

10. The component of claim 1 further comprising less than about 10 weight percent of an inorganic filler.

11. The component of claim 10 wherein said filler is selected from glass fibers and glass flakes.

12. The component of claim 10 further comprising one or more additives.

13. The component of claim 12 wherein said one or more additives are independently selected from the group consisting of stabilizers, antioxidants, lubricants, flame retardants and colorants.

14. The component of claim 1 wherein said thermally conductive material is incorporated in an amount from about 25 to about 70 weight percent.

15. The component of claim 1 wherein said thermally conductive material is incorporated in an amount from about 30 to about 50 weight percent.

16. The component of claim 1 wherein said thermally conductive material is selected from the group consisting of Al2O3, boron nitride, boron carbide, calcium fluoride, and aluminium nitride.

17. The component of claim 16 wherein said thermally conductive material is selected from the group consisting of Al2O3, boron nitride, calcium fluoride, and boron carbide.
